(19) United States
(12) Patent Application Publication
(10) Pub. No.: US 2006/0070863 A1
(43) Pub. Date: Apr. 6, 2006

(54) Knob module

(75) Inventors: Chen-Kuang Yeh, Taipei City (TW); Fu-Lin Yang, Taipei City (TW)

Correspondence Address: TROXELL LAW OFFICE PLLC, SUITE 1404, 5205 LEESBURG PIKE, FALLS CHURCH, VA, 22041, US

(73) Assignee: Premier Image Technology Corporation

(21) Appl. No.: 10/958,355

(22) Filed: Oct. 6, 2004

(51) Int. Cl. H01H 19/14

(52) U.S. Cl. 200/336

(57) ABSTRACT

A knob module is set on a circuit board of an electric device and comprises: a pedestal fixed on the circuit board with a plurality of interference parts and a pivotally connecting part; a rotative body with a plurality of pivotally connecting bodies corresponding to the pivotally connecting part and a plurality of interference bodies corresponding to the interference part, the rotative body is connected to the pedestal by pivotally connecting the pivotally connecting bodies with the pivotally connecting part, the interference bodies are interfered with the interference part, respectively; and, an elastically contacting piece is fixed on the rotative body, a first contacting part and a second contacting part of the elastically contacting piece are situated on the outer and inner circle of the pivot rod, the first contacting part and a second contacting part are electrically connected to corresponding places of the circuit board.

### BACKGROUND OF THE INVENTION

1. Field of the Invention

The present invention is related to a knob module, and especially to a module applied on electrical multi-media products made by different factories for being assembled quickly.

2. Description of Related Art

Prior art controlling knobs are made for function choices (as mode selection knobs for digital cameras or PDAs). Generally, the controlling knobs are designed for specific electrical products, and cannot be used for other products even though the products are all designed in the same factories. Therefore, a new mold for knobs is always needed when producing a new product.

Furthermore, the number of functions or modes is different between electrical products made by different factories. For this reason, a controlling knob isn't used for different electrical products.

Moreover, structures of prior art controlling knobs are too complicated and their cost too high.

### SUMMARY OF THE INVENTION

The objectives of the present invention are to modularize controlling knobs, simplify the structure of the knobs thus allowing quick assembly, and lower the costs of production. Different factories or stores can only change the circuit design of the circuit board and set additional fixed holes for the same knobs. Furthermore, the knobs are preset with more option connecting points so that they can be the used with all electrical products.

The present invention provides a knob module set on a circuit board of an electrical product, and comprises:

a pedestal fixed on the circuit board with a plurality of interference parts and a pivotally connecting part;

a rotative body with a plurality of pivotally connecting bodies corresponding to the pivotally connecting part and a plurality of interference bodies corresponding to the interference part; the rotative body is connected to the pedestal by pivotally connecting the pivotally connecting bodies with the pivotally connecting part; the interference bodies interfer with the interference part, respectively; and

an elastically contacting piece fixed on the rotative body; a first contacting part and a second contacting part of the elastically contacting piece are situated on the outer and inner circle of the pivot rod; the first contacting part and the second contacting part are electrically connected to corresponding places on the circuit board.

### BRIEF DESCRIPTION OF THE DRAWINGS

FIG. 1 shows an exploded view of a first embodiment of the present invention;

FIG. 2 shows a combination diagram of the first embodiment of the present invention;

FIG. 3 shows a bird's eye view of the first embodiment of the present invention;

FIG. 4 shows a 4-4 cross-sectional view of the first embodiment of the present invention; and

FIG. 5 shows an exploded view of a second embodiment of the present invention.

### DETAILED DESCRIPTION OF PREFERRED EMBODIMENTS

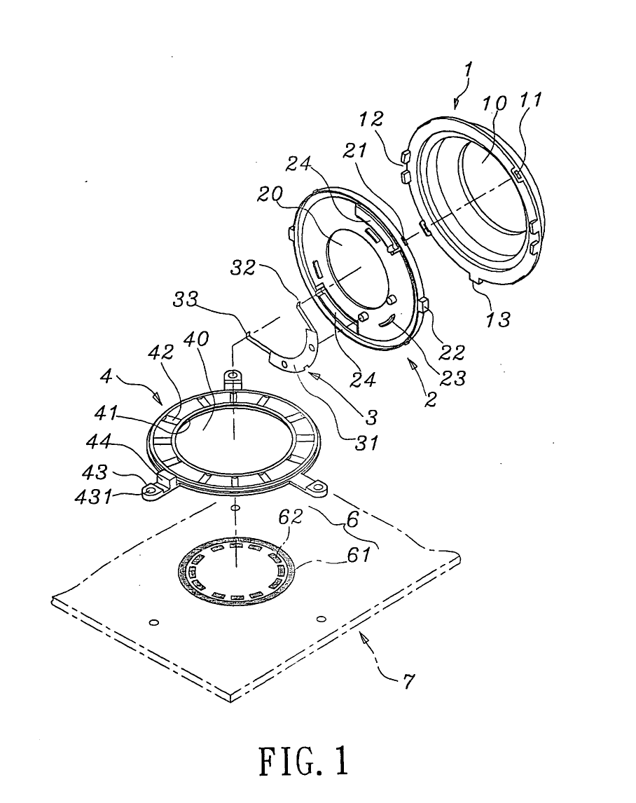

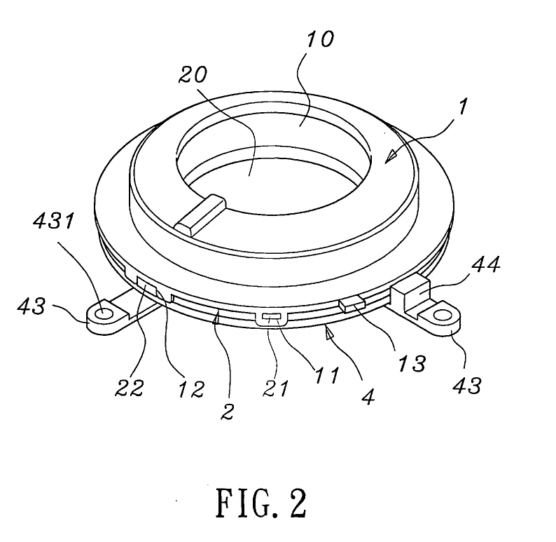

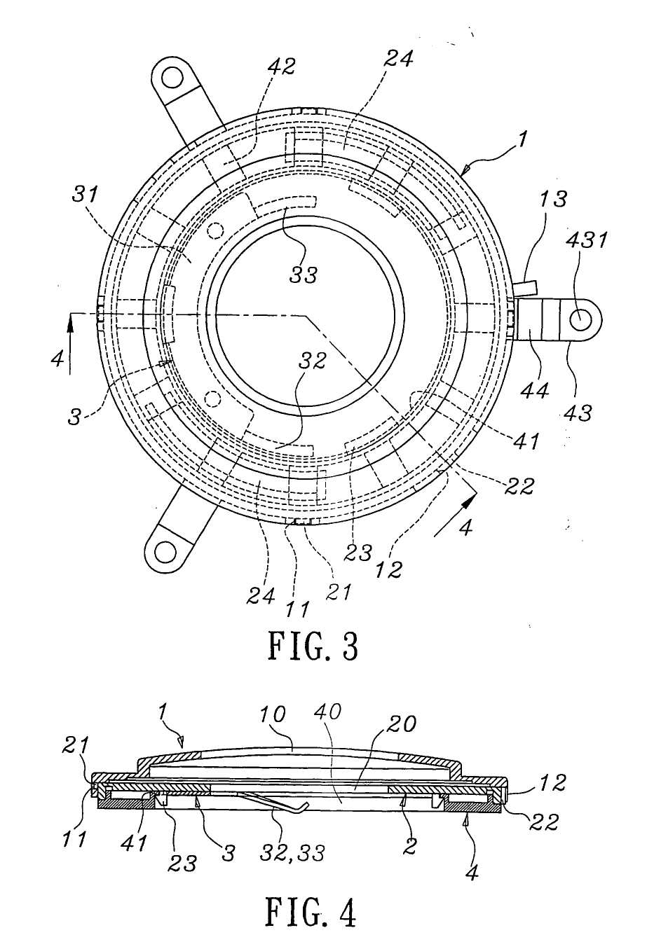

The first embodiment is shown in FIG. 1 to FIG. 4. The present invention provides a knob module which is modularized for being electrically set on a circuit board 7 of electric products, and the knob module provides various function selections and mode selections. The knob module mainly comprises a rotative body 2, an elastically connecting piece 3, and a pedestal 4. The module further comprises a shell 1 and a collocating structure 5 for improving the functions of the knobs.

The pedestal 4 is shaped into a hoop with a pierced hole 40 formed on the center of the pedestal 4 and a plurality of stretching parts 43 are protruded around the pedestal 4. Besides, every free terminal of the stretching part 43 has a corresponding hole 431 for fixing the pedestal 4 onto the circuit board 7 (by using spirally connecting units). A pivotally connecting part 41 with a circle of protruding edge type is formed at the upper part of the inner edge of the pierced hole 40, and a plurality of interference parts 42 in concave trench shapes circles around the pedestal 4. Moreover, a stop plate 44 is set protrudently on the stretching part 43 for stopping the rotating amplitude of the stretching part 43.

Further, the rotative body 2 includes a plurality of pivotally connecting bodies 23 corresponding to the pivotally connecting part 41 and a plurality of interference bodies 24 corresponding to the interference part 42. The rotative body 2 is connected to the pedestal 4 by pivotally connecting the pivotally connecting bodies 23 with the pivotally connecting part 41; the interference bodies 24 are interfered with the interference part 42 for producing a multi-stage rotating orientation effects. Besides, the pivotally connecting bodies set on the rotative body are preferably made of hooks corresponding to the protruding edge (pivotally connecting part 41). Therefore, the pivotally connecting part bodies 23 are all hooked on the pivotally connecting part 41 and the rotative body 2 can be pivotally connected to the pedestal 4 for rotation. The interference bodies 24 can be elastic arms and it comprises of at least one pair of elastic arms; the free terminals of the interference bodies of the elastic arms are interfered with the interference parts 42 to make multi-stage orientation effects.

Moreover, the elastically contacting piece 3 includes a fixed part 31 of the rotative body 2, a first contacting part 32 and a second contacting part 33; the first contacting part 32 and the second contacting part 33 are protruded at two terminals of the fixed part 31 and situated on the outer and inner circle of the pivot rod; the first contacting part 32 and a second contacting part 33 are also situated within the range of the pierced hole 40 of the pedestal 4; hence, the first contacting part 32 and a second contacting part 33 can electrically connect to a corresponding circuit 6 of the circuit board 7.

The circuit board 7 includes the corresponding circuit 6 which corresponds to the first contacting part 32 and the second contacting part 33. The corresponding circuit 6 includes a conducting hoop 61 and a plurality of connecting points 62 set in the inner the circle of the conducting hoop 61. The conducting hoop 61 is used for electrically contacting the first contacting part 32 (as a common electrode) and the connecting points 62 are used for electrically contacting with the second contacting part 33. Therefore, when the rotative body 2 is rotated, the first contacting part 32 will be constantly contacted with the conducting hoop 61; further, according to the rotation angle of the rotative body 2, the second conducting part 33 will contact with one of the connecting points for electrical conduction and some kind of mode or function will be thus activated. Moreover, when the rotative body 2 is rotating, the interference bodies 24 are interfered with by the interference parts 42 of the pedestal 4 in order; so, the number of interference parts 42 corresponds to the number of connecting points 62 and every section the rotative body rotates will produce an interfered orientation effect.

The present invention further comprises a shell 1 which is fixed to the rotative body 2. So the shell 1 can spin synchronously with the rotative body 2, a plurality of stop parts 12 and fixedly connecting parts 11 are set around the shell 1. A plurality of stop bodies 22 and fixedly connecting components 21 corresponding to the stop parts 12 and fixedly connecting parts 11 are set around the rotative body 2; the stop bodies 22 are stopped by the stop parts 12 for rotating the shell 1 synchronously with the rotative body 2 and the fixedly connecting components 21 are connected to the fixedly connecting parts 11 for connecting the shell 1 with the rotative body 2. Furthermore, for limiting the rotation amplitude of the shell 1 and the rotative body 2, the shell 1 further includes a projection 13 and a stop plate 44 which is set on the stretching part 43; the stop plate 43 is positioned in the rotating path of the projection 13 for stopping the rotation of the shell 1 as well as the rotative body 2.

However, in FIGS. 1 to 4, a pierced hole 10 and a pierced hole 20 exist on the shell 1 and the rotative body 2. Because the pierced hole 10 and the pierced hole 20 are used for the collocating structure 5, they do not appear in the first embodiment and can be sealed.

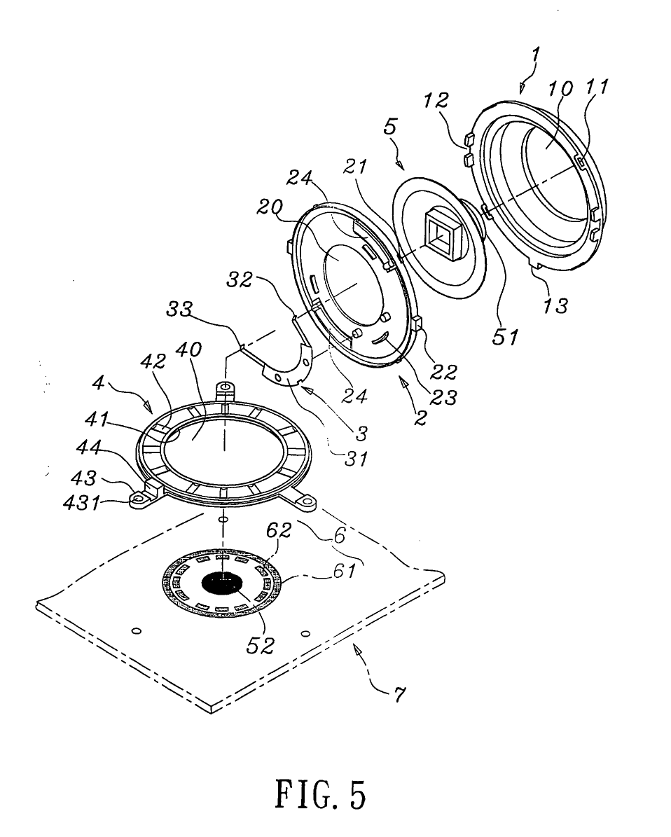

Please refer to a second embodiment in FIG. 5, it mainly shows a collocating structure 5 set between the shell 1 and the rotative body 2. With the additional structure, the functions of the knob module are increased. Owing to the fact that the collocating structure 5 is set between the shell land the rotative body 2, pierced holes 10, 20 are set on the shell 1 and the rotative body 2, respectively. The collocating structure 5 protrudes partly to the pierced hole 10 of the shell 1 and electrically connects to a corresponding part of the circuit board 7 through the pierced hole 20 of the rotative body 2. For example, the collocating structure 5 can include an operation body 51 set between the shell 1 and the rotative body 2, and a multi-direction switching body 52 connected electrically to the circuit board 7; the operating body 51 is connected to the multi-direction switching body 52 mechanically and thus the multi-direction switching function is added to the present invention.

The present invention modularizes the prior art controlling knobs. Hence, only change of the circuit design (corresponding circuit 6) and additional fixed holes (not labeled) on the circuit board 7 for fixing the pedestal 4 are needed, and the knobs can be used by every electrical product that uses knobs. Further, the structure of the knob module is simplified for lowering production costs and quick assembly. Moreover, enough optional connecting points (twelve connecting points 62 are shown in the figure) are preset on the knob module, and the number of the connecting points surpasses the demand of electrical products on knobs. However, unnecessary connecting points 62 will not be electrically connected to the circuit board 7 and a collocating structure 5 is added for raising the functions of the module.

What is claimed is

1. A knob module set on a circuit board of a electric device, comprising:
a pedestal fixed on the circuit board with a plurality of interference parts and a pivotally connecting part;
a rotative body with a plurality of pivotally connecting bodies corresponding to the pivotally connecting part and a plurality of interference bodies corresponding to the interference part, wherein the rotative body is connected to the pedestal by pivotally connecting the pivotally connecting bodies with the pivotally connecting part, and the interference bodies are interfered with the interference part, respectively; and
an elastically contacting piece fixed on the rotative body having a first contacting part and a second contacting part of the elastically contacting piece situated on the outer and inner circle of the pivot rod, the first contacting part and the second contacting part electrically connected to corresponding places on the circuit board.

2. The knob module as in claim 1, wherein the pedestal further includes a pierced hole, and a pivotally connecting part with a circle of protruding edge type is formed at the upper part of the inner edge of the pierced hole; the pivotally connecting bodies set on the rotative body are hook-shaped and correspond to the protruding edge; the pivotally connecting hook-shaped bodies are clipped and connected to the pivotally connecting.

3. The knob module as in claim 1, wherein the interference bodies on the rotative part comprises at least one pair of elastic arms, and the free terminals of the elastic arms are interfered with the interference parts of the pedestal.

4. The knob module as in claim 1, wherein the pedestal further includes a pierced hole; the first contacting part and a second contacting part of the elastically contacting piece are stretched to the pierced hole and electrically connected to the corresponding placed on the circuit board.

5. The knob module as in claim 1, wherein the circuit board further includes a corresponding circuit which has a conducting hoop corresponding to the outer circle of the pivot rod and a plurality of connecting points corresponding to the inner circle of the pivot rod.

6. The knob module as in claim 1, further comprising a shell fixed on the rotative body and the shell spins synchronously with the rotative body.

7. The knob module as in claim 6, wherein the shell further includes a projection and a stop plate, and the stop plate positioned in the rotating path of the projection for stopping the rotation of the shell and the rotative body.

8. The knob module as in claim 6, wherein a plurality of stop parts and fixedly connecting parts are set around the shell; a plurality of stop bodies and fixedly connecting components corresponding to the stop parts and fixedly connecting parts are set around the rotative body; the stop bodies are stopped by the stop parts for rotating the shell synchronously with the rotative body and the fixedly connecting components are connected to the fixedly connecting parts for connecting the shell with the rotative body.

9. The knob module as in claim 6, further comprising a collocating structure set between the shell and the rotative body; pierced holes are set on the shell and the rotative body, respectively and the collocating structure protrudes partly to the pierced hole of the shell and electrically connects the circuit board through the pierced hole of the rotative body.

10. The knob module as in claim 9, wherein the collocating structure includes a operation body set between the shell and the rotative body, and a multi-direction switching body connected electrically to the circuit board; the operating body is connected to the multi-direction switching body mechanically.
